(19) United States
(12) Patent Application Publication
(10) Pub. No.: US 2020/0022217 A1
(43) Pub. Date: Jan. 16, 2020

(54) NETWORK RANGE AND CONNECTIVITY IMPROVEMENT

(71) Applicant: British Telecommunications Public Limited Company, London (GB)

(72) Inventors: Simon RINGLAND, London (GB); Francis SCAHILL, London (GB); Timothy TWELL, London (GB)

(73) Assignee: British Telecommunications Public Limited Company, London (GB)

(21) Appl. No.: 16/335,417

(22) PCT Filed: Sep. 22, 2017
(86) PCT No.: PCT/EP2017/074056

§ 371 Date: Mar. 21, 2019

(30) Foreign Application Priority Data
Sep. 29, 2016 (EP) 16191611.9

(51) Int. Cl. H04W 88/06; H04W 84/12; H04W 76/16; H04W 72/08; H04W 4/80; H04L 12/28

(52) U.S. Cl. CPC H04W 88/06; H04W 84/12; H04L 12/2834; H04W 72/082; H04W 4/80; H04W 76/16

(57) ABSTRACT

In hybrid access broadband systems, bandwidth provided via a Digital Subscriber Line or cable broadband link is supplemented with bandwidth provided by a Long Term Evolution cellular data link. A user device having both wireless local area network and LTE network access is used to simulate an LTE modem. The performance of a data connection to the LTE network and a home gateway via a WLAN is measured at various locations within the user premises. The results are processed to determine the hybrid access benefit provided at the various locations and a recommended location for installation of the LTE modem is determined for the user premises.

### CROSS-REFERENCE TO RELATED APPLICATION

The present application is a National Phase entry of PCT Application No. PCT/EP2017/074056, filed Sep. 22, 2017, which claims priority from EP Patent Application No. 16191611.9 filed Sep. 29, 2016 each of which is hereby fully incorporated herein by reference.

### TECHNICAL FIELD

The present disclosure relates to hybrid access broadband and in particular to a method for improving the placement of a cellular modem device which supplements a wired broadband connection.

### BACKGROUND

In a wired broadband system, user devices such as computers, smartphones, smart televisions etc., hereinafter referred to as customer premises equipment (CPE) located in a user premises such as a home or office, can communicate with computing resources and other users located on a wide area network (WAN) such as the Internet. The user premises is not directly connected to the WAN, instead their connection is routed via an Internet Service Provider (ISP) which also provides various control functions such as public Internet Protocol (IP) Address allocation, traffic shaping and billing.

The ISP is connected to a user premises via a physical network. In a Digital Subscriber Line (DSL) broadband system, the connection is the telephone network. A copper telephone line twisted pair that is traditionally used for voice, carries data traffic between a modem in the user premises to a telephone exchange servicing a number of user premises. From the exchange, the data is sent to an ISP associated with the user premises for onward transmission to resources located on the WAN.

The speed of the broadband service is primarily dependent on the length of the copper line between the user premises and the exchange. To address this issue, many DSL systems replace lengths of copper with optical fiber which has a higher capacity/bandwidth. In an Asynchronous DSL (ADSL2+) service, a line can achieve up to 24 Mbps. To replace more of the copper length, a Fiber to the Cabinet (FTTC) broadband system using VDSL relies on street side cabinets linked to the exchange with optical fiber. The remaining copper length is reduced to under 300 m, the resulting improvement in copper bandwidth allowing speeds of over 76 Mbps. Fiber to the Premises (FTTP) installations completely replace the copper link with an optical connection between the user premises and the exchange allowing for over 1 Gbps.

Whilst it is generally desirable to improve broadband speeds by replacing a larger proportion of the copper link to the ISP with optical fiber, economic and geographical restrictions can prevent the deployment of an all fiber network in many locations.

For long lines where it is not possible to replace any significant sections of the copper link to the exchange, the capacity of the line can be very low. As a result the user will have a reduced quality of experience for any Internet interactions such as file downloads, web browsing etc. due to the bandwidth and/or latency constraints. For example, bandwidth is required for faster file transfers and for improved video resolution/frame rate in video streaming. For other applications, latency is more important, for example, low latency is required for real time services. Similarly, audio calling does not require high bandwidth, but low latency.

### SUMMARY

Described embodiments aim to address the above problems. In one aspect, an embodiment provides a method of assessing potential locations for a hybrid access modem for connection to a hybrid access home gateway, the method being performed by a device having both a cellular interface and a wireless local area network data interface and comprising: retrieving a plurality of data sets of performance data at various locations within the physical premises, each set comprising cellular network metrics and wireless local area network metrics; determining a utility score for each of the data sets, the utility score representative of suitability for a hybrid access modem placement; and identifying a recommended location for a hybrid access modem.

In another aspect, an embodiment provides, an apparatus for assessing potential locations for a hybrid access modem for connection to a hybrid access home gateway, comprising: a cellular interface; a wireless local area network data interface; means for retrieving (for example, a receiver) a plurality of data sets of performance data at various locations within the physical premises, each set comprising cellular network metrics and wireless local area network metrics;

means for determining (for example, a processor) a utility score for each of the data sets, the utility score representative of suitability for a hybrid access modem placement; means for identifying (for example, a or the processor) a recommended location for a hybrid access modem; and means for displaying (for example, a display) the recommended location of the hybrid access modem.

### BRIEF DESCRIPTION OF THE FIGURES

Embodiments of the present disclosure will now be described with the aid of the accompanying Figures in which:

FIG. 1 shows an overview of a home broadband setup in accordance with a first embodiment.

FIG. 2 shows an example user premises.

FIG. 3 shows the user premises of FIG. 2 with a recommended cellular modem location overlay.

FIG. 4 shows a mobile device used in the first embodiment to recommend a cellular modem location in the user premises.

FIG. 5 shows the functional components of the mobile device.

### DESCRIPTION

### Overview

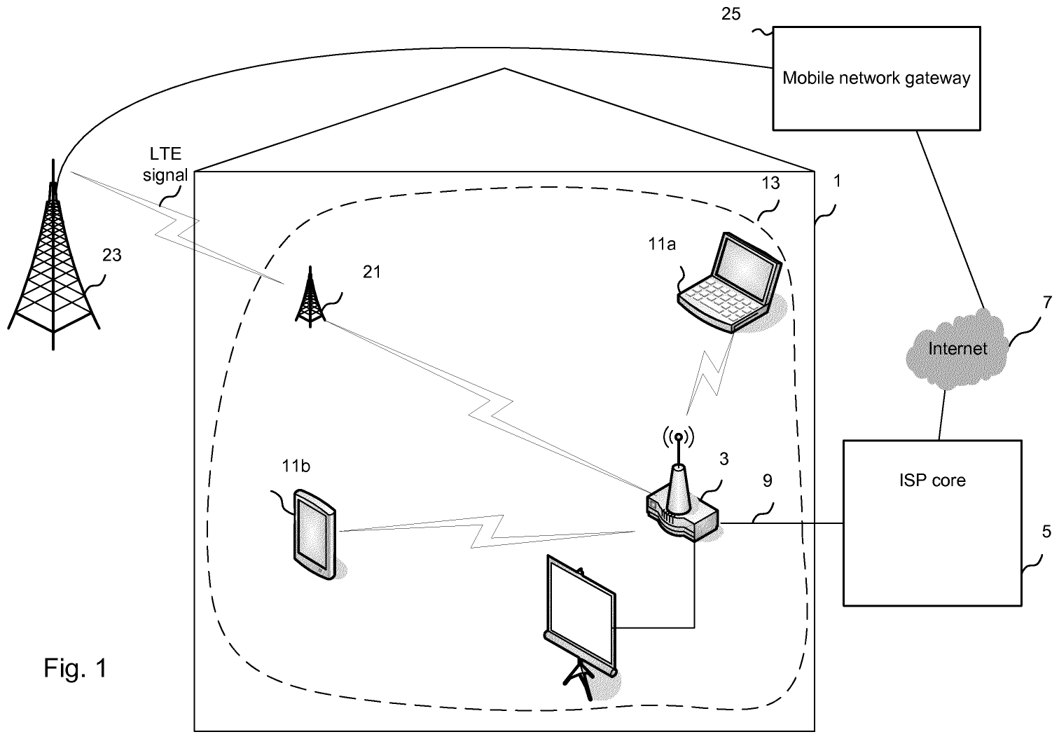

FIG. 1 shows an overview of a “hybrid access” user premises broadband setup in accordance with a first embodiment.

A user premises 1 such a user's home contains a home gateway device 3 hereinafter referred to as a hub 3. The hub 3 is a combined device providing the functions of a modem, a router and a wireless access point. The modem section connects to an Internet Service Provider 5 which manages a connection to a Wide Area Network (WAN) such as the Internet 7. Various technologies can be used to provide the data link to the ISP 5 and in this embodiment, the modem part of the hub 3 is a Digital Subscriber Line (DSL) modem connected to the ISP 5 via a telecommunications network so that Asynchronous DSL (ADSL) protocol is used over a data link 9.

In DSL, the data link 9 is carried over a copper based Public Service Telephone Network (PSTN) wherein a copper twisted pair links the user premises to a telephone exchange. The speed of the data link at the user premises is dependent on the copper length to the exchange which can vary from hundreds of meters to several kilometers. At the exchange, a fiber based backhaul carries any data signals to the ISP and on towards data resources on the Internet.

The Wireless Access Point (WAP) section of the hub 3 is responsible for providing connectivity to a number of devices having wireless interfaces, hereinafter referred to as wireless devices 11, located within the user premises 1. Typical wireless devices 11 include laptops, computing tablets, smart phones, etc.

The WAP generates a wireless local area network (WLAN) 13 which is a wireless private network extending throughout the user premises 1 and wireless devices 11 within the WLAN 13 can communicate with the WAP of the hub 3. In this embodiment, the WAP generates a WLAN 13 in accordance with at least one of the IEEE 802.11 family of wireless protocols more commonly referred to as Wi-Fi™. For ease of explanation, the WAP creates a single-band WLAN using 802.11n which provides for WLANs operating in the 2.4 GHz spectrum.

Wireless devices 11 supporting the same wireless protocol as the WAP can connect to the WLAN at a connection speed which varies according to distance from the hub 3 and the presence of interference or attenuation. For example, devices in the same room are likely to connect at the maximum data rate, while devices located on a different floor and separated via several walls will connect at a much lower data rate, if at all.

The router part of the hub 3 is responsible for routing data packets between the private local network side WLAN 13 created by the WAP and the modem so as to link local devices connected with the WAP to resources located on the Internet 7. The hub 3 can also be connected to wired devices 15 such as network capable televisions via Ethernet and the router part of the hub 3 also routes data packets between any wireless devices 11 and wired devices 15 and between wired devices 15 and resources on the Internet 7.

The data connectivity speed between two devices, for example from a resource on a WAN such as the Internet 7 and a user device 11, 15 in the user premises 1 is rate limited to the slowest data link in the chain of connectivity. For user premises which are located many kilometers from the exchange, the slowest link is often the DSL link 9 between the hub 3 and the exchange because of the distances between the two end points. In conventional copper line links, the speed of ADSL has a maximum speed of 24 Mbps but where the line is several kilometers long, the data rates can be below 2 Mbps.

For many data services such email, data transfer and web browsing a low speed is inconvenient. However for real time services, the data rates may be so low that packets cannot be delivered in time resulting in the service being unable to function at all. Examples are stuttery video on demand and video conferencing where latency is highly noticeable.

So called “last mile” solutions have been developed to increase DSL speeds by replacing sections of the DSL link 9 between the user premise and the exchange with optical fiber. Different fiber deployments are known such as Fiber to the Cabinet (FTTC), Fiber to the Distribution Point (FTTdp) and Fiber to the Premises (FTTP) which replace or even eliminate the amount of copper cable in the link from the ISP 5 to the user premises 1. The resulting shorter lengths of copper can support greater bandwidths to the user premises 1 using VDSL and G.Fast modems.

However, replacing the existing copper lines with optical fiber is an expensive and labor intensive operation and therefore there are some user premises with lines which cannot be upgraded with a partial fiber link due to economic or geographic limitations.

### Hybrid Access

To address improving speeds on these lines, a combined DSL and cellular solution known as “Hybrid access” has been proposed. In hybrid access, the wired landline broadband connection is supplemented by a second wireless data connection, in this embodiment, a cellular network data link using the Long Term Evolution (LTE) protocol. An LTE modem 21 connects to a macrocell 23 forming part of a Radio Access Network (RAN) of a cellular data network containing a mobile network gateway 25. The mobile network gateway 25 connects cellular network clients such as the LTE modem 21 and LTE capable cellular devices such as smartphones to the Internet 7.

In this embodiment, the LTE modem 21 also connects to the hub 3 as a WLAN client. The router section of the hub 3 further includes a channel bonding function so that the bandwidth from both data links are combined to create a single virtual data link from the perspective of user devices connected to the hub 3. In this way, the supplemental bandwidth of the LTE link can be added to the bandwidth of the DSL connection 9 to provide enough bandwidth for supporting video streaming and interactive real time services such as video calling. The channel bonding function re-orders data packets belonging to the same data session but received via both the DSL and LTE link. It is also responsible for deciding how outgoing packets are transmitted via the DSL and LTE links.

Since cellular data networks are another form of a wireless transmission protocol, the speed of the data connection to the hub 3 is also affected by the distance to the LTE macrocell 23 serving the LTE modem 21 and any local sources of interference/attenuation.

In particular, the additional bandwidth is limited by the lowest performing of the LTE modem 21 connections, namely

a) LTE modem 21 to macrocell 23 via LTE; and

b) LTE modem 21 to hub 3 via the WLAN 13.

The mobile network operator (MNO) maintaining the LTE cellular data network will have planned the distribution of the macrocell sites so that cellular coverage will be available across a large geographical area. However, due to the transmission frequencies licensed for cellular network transmissions, the cellular signal strength inside buildings may be much weaker than outdoor areas due to attenuation. For example, cellular networks operating in the 3.2 GHz spectrum can provide higher bandwidth than a cellular network operating at 800 MHz range, but has less range and is more sensitive to attenuation. Therefore the positioning of the LTE modem 21 within the user premises 3 has an impact on the addition potential bandwidth provided by the LTE modem 21.

The link a) is maximized by placing the LTE modem in a high position and near a peripheral part of the user premises such as an exterior wall and window. However, when the LTE modem 21 and hub 3 are connected wirelessly, link b) is maximized by placing the LTE modem 21 near the hub 3. The placement of the hub 3 is generally restricted by the location of the telephone master socket entering the home and this may not always be near a window or the perimeter of the user premises. Therefore, while there will be some user premises 1 where the LTE modem 21 and hub 3 can be co-located with both link a and link b maximized, a significant percentage of user premises 1 will have master sockets located in areas where the cellular signal may be subject to interference and attenuation and therefore link speeds from the LTE modem 21 to the macrocell 23 would be low.

The first embodiment relates to a method of determining an optimal location for placing a LTE modem 21 in a user premises 1.

As will be described below, the method involves collecting pairs of link a) and link b) sample data points around the user premises 1. In this embodiment, this data is acquired by a user and a user device such as smartphone 11b having both a WLAN adaptor connected to the WLAN 13 and a cellular adaptor and a Subscriber Identity Module (SIM) subscribed to the same cellular network as the LTE modem to be installed in the user premises. After a number of pairs of sample data have been collected, the sample data is analyzed to identify a location within the user premises 1 for the LTE modem.

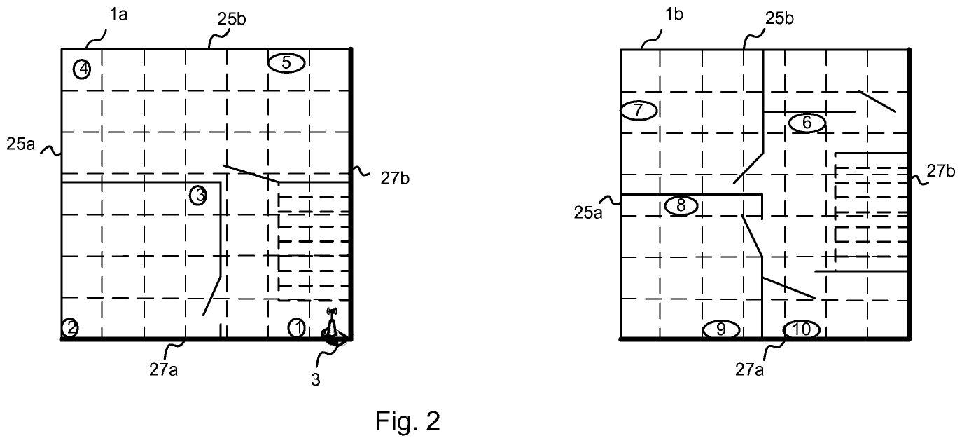

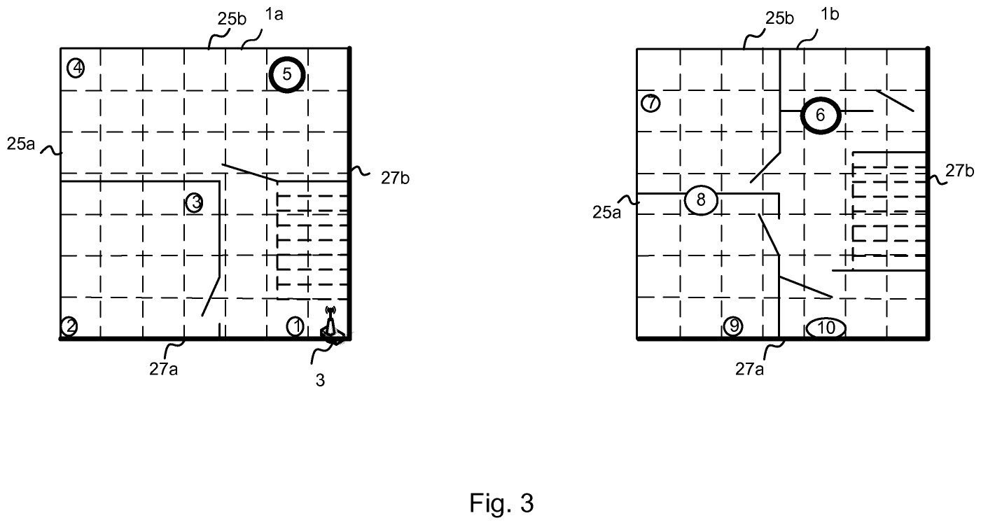

An example of the visualizations displayed to the user via the user device are shown in FIGS. 2 and 3.

FIG. 2 shows a user premises 1 which is a two-level house (ground floor 1a and first floor 1b). As shown, two sections of the house are external walls 25a, 25b, while another two are adjoining walls 27a, 27b with other user premises which will affect the reception of cellular signals.

The hub 3 is located by the master socket which is at a corner of the user premises 1 on the ground floor 1a. The user is directed to use the scanning smartphone 11b to collect data samples at various locations on both floors 1a, 1b. In this example, the sample locations are located in the general vicinity of a power socket so that the eventual LTE modem 21 has access to a power source.

After the samples have been collected, the data is processed to determine a recommended location and the results are displayed to the user.

FIG. 3 shows the results of the processing of the first embodiment whereby the sample points for the house la collected in FIG. 2 have been analyzed.
Sample 1 is a location with strong WLAN reception (link b) due to the proximity to the hub, but the LTE reception (link a) is weak due to the internal location away from the exterior walls;
Sample point 4 is a location with strong LTE reception (link a) but weak WLAN reception (link a) due to the distance from the hub;
Sample point 9 is a location with weak WLAN reception (link b) and weak LTE reception (link a). The weak WLAN reception is due to the thickness of the floor or a local source of interference;
Sample point 6 is a location with strong LTE reception (link a) and strong WLAN reception (link b).

As shown, from the sample data, locations 5 and 6 are the recommended locations for the LTE modem 21. In FIG. 3 the recommended location is indicated as a larger circle and thicker border. The size of the circle and thickness of line reduce in accordance of the suitability of other sample points. In FIG. 3, sample location 4 and 9 are the worst locations and therefore have the smallest circles.

Color is also used for example green for recommended locations and red for not-recommended locations.

In this way, the user is provided with guidance based on actual data link quality measurements around the user premises as to where to place a LTE modem which will maximize the performance benefit of the hybrid access broadband in the user premises 1.

### Wireless Device

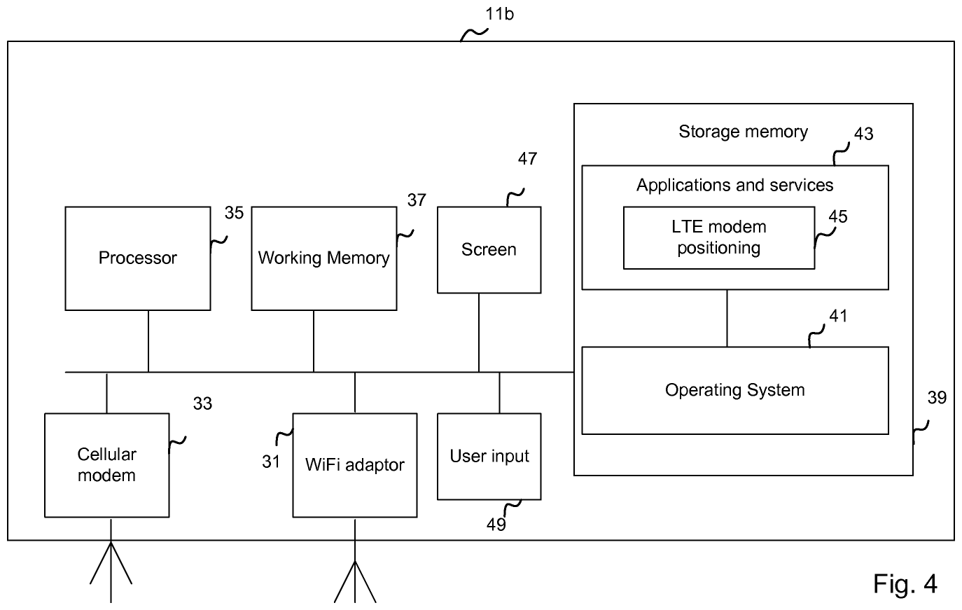

FIG. 4 shows an overview of the physical components of a wireless device 11b which is configured to simulate a LTE modem 21 and perform the sampling and recommendation processing. The wireless device 11b has a WLAN adaptor 31 for communication with the hub 3 and also a cellular adaptor/modem 33 for communication with the cellular network macrocell 25. The wireless device also includes a data processor 35, working memory 37 and storage memory 39. The storage memory contains data which when loaded into working memory and processed by the processor 35 defines a wireless device operating system 41 and also a set of applications 43 including in the first embodiment an LTE modem positioning application 45. The LTE modem positioning application 45 configures the wireless device 11b to function as a LTE modem position tester. The wireless device also includes a screen 47 and user input 49 such as a touch screen and/or keyboard.

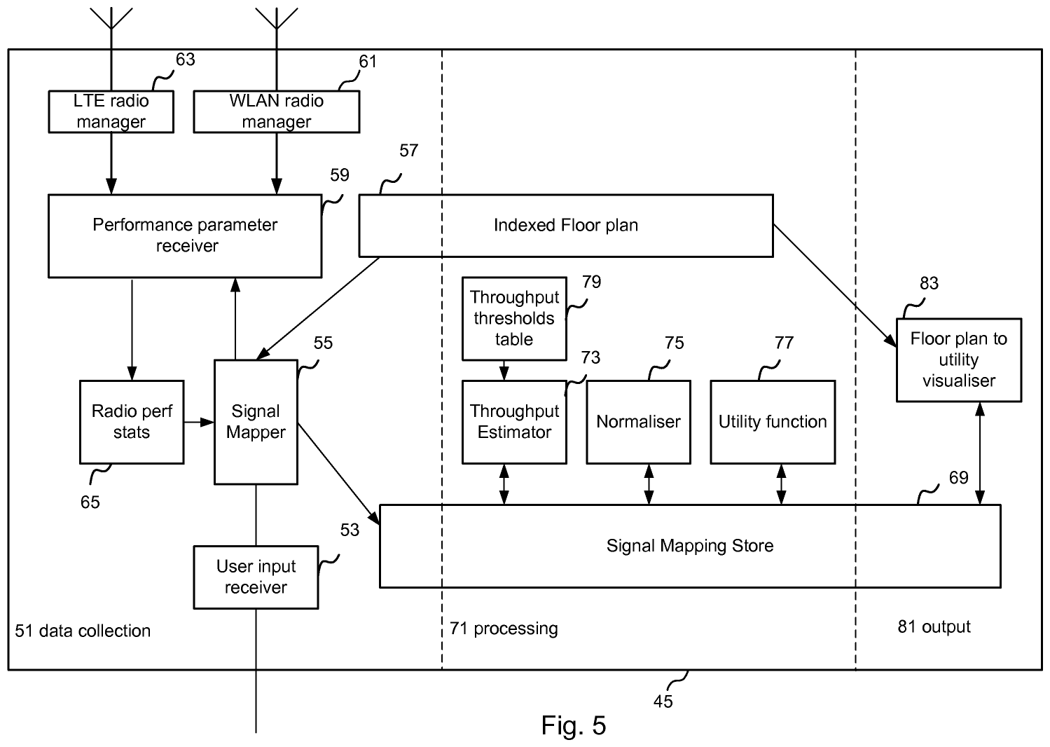

To improve understanding of the first embodiment, FIG. 5 shows the functional components of the wireless device 11b when the processor 35 is executing the application 45 and therefore the wireless device is configured to operate in accordance with the LTE modem positioning application 45.

The functionality can be divided into three sections, a sample data input section 51 for gathering sample data, a processing section 71 for identifying an optimal location for a LTE modem 21 and an output section 81 for displaying the results to the user.

### Sample Data Input Section 51

The input section 51 is responsible for collecting sample point data at various locations around the home and associating the set of data with a location in the user premises. The input section 51 includes a user input receiver 53, a signal mapper 55, a floor plan data store 57, a performance parameter receiver 59, a WLAN adaptor manager 61, an LTE modem manager 63 and radio performance parameter data store 65 and a signal mapping store.

When the LTE modem positioning application 45 is running on the wireless device 11b, processing is initiated when the user input receiver 53 receives an input from the user via user input 49 that they wish to initiate the sampling process. The input receiver 53 forwards the message to the signal mapper 55 which is responsible for gathering sensor data to enable a LTE modem location to be recommended to the user.

Ideally the LTE modem operation is performed at a “quiet time” when no/few other WLAN devices are sending data which would affect the reported WLAN metrics.

The user first needs to upload a floor plan of the user premises to be tested. The signal mapper 55 receives a floor plan image for the user premises 1 via the user input receiver 53 and then performs a simple grid mapping function so that points on the uploaded floor plan can be referenced with an x, y, z coordinate location code. For example, as shown in FIGS. 2 and 3, the bottom left grid reference on the ground floor is assigned the grid reference 0, 0, 0, while the top right grid reference on the first floor is 6, 6, 1. In this embodiment, the x and y coordinate of each grid reference relates to a 1×1 square meter area while the z coordinate indicates a floor level. This floor plan is stored in the floor plan store 57.

The grid referenced floor plan is displayed on a screen 47 of the wireless device and the user is then asked to move to the location of the hub 3 within the user premises 1 and then indicate the location of the hub on the floor plan.

Once data is received the signal mapper instructs a performance parameter receiver 59 to use the WiFi radio manager 61 and LTE radio manager 63 to obtain performance metric data at that location of the hub 3. The WiFi radio manager 61 is a controller for the WiFi adaptor hardware 31 and the LTE radio manager 63 is a controller for the LTE modem 33. Reading the performance metrics of a data connection via the WLAN link and LTE link respectively at this location gives an indication of the effect of the hub 3 and LTE modem 21 being co-located at the same position.

In this embodiment, the LTE radio manager 63 obtains a Reference Signal Receive Power (RSRP) value and a Signal-to-Interference-Noise-Ratio (SINR) for each sample location. The WiFi radio manager 61 obtains a Received Strength Signal Indication (RSSI) value and SINR value.

The data from the WLAN radio interface 61 and the data from LTE radio interface 63 are separately received by the performance parameter receiver 59 and stored in a radio performance statistics data store 65 indexed to the first sample point.

An example of the types of measurement values for each metric at the first location is shown below.

### LTE Measurements

RSRP=−110 dBm

SINR=5

### Wi-Fi Measurements

RSSI=−51 dBM

SINR=25.8

Once stored, the user is asked to move to a new candidate location for the LTE modem 21 within the user premises 1. In this embodiment, the user is asked to move to the location of a power socket within the user premises 1 since the LTE modem will require mains power.

Once the user has arrived at the new location, they can select the new location on the displayed floor plan and instruct a new scan. In response to this user input, a new set of performance metric data is collected and stored in the radio performance stats store 65. The signal mapper 55 then associates the collected set with the grid reference associated with the user press on the floor plan 57 and stores the complete mapping in signal mapping store 69.

The process is repeated for each location that the user requires a scan which in this embodiment is the location of a mains power socket within the home.

Table 1 below shows example scan values received by the LTE radio interface 63 and WiFi radio interface 61 at the some of the scan locations shown in FIG. 2.

TABLE 1

| | LTE measurements | | WiFi measurements | | User |
|---|---|---|---|---|---|
| | RSRP | SINR | RSSI | SINR | location |
| Sample # | (dBm) | (dB) | (dBm) | (dB) | grid ref |
| 1 | −120 | 0 | −51 | 25.8 | 5, 0, 0 |
| 2 | −60 | 30 | −68 | 8.8 | 0, 0, 0 |
| 3 | −110 | −5 | −57 | 8.8 | 3, 3, 0 |
| 4 | −70 | 25 | −71 | 8.8 | 0, 6, 0 |
| 5 | −70 | 25 | −59 | 17.8 | 5, 6, 0 |
| 6 | −80 | 20 | −59 | 15.8 | 4, 5, 1 |
| 7 | −60 | 30 | −77 | −0.2 | 0, 5, 1 |
| 8 | −90 | 20 | −68 | 8.8 | 1, 3, 1 |
| 9 | −100 | 10 | −71 | 5.8 | 2, 0, 1 |
| 10 | −110 | −5 | −59 | 17.8 | 4, 0, 1 |

When the user has finished scanning the user premises, they can indicate to the application 45 that all scan locations have been received.

### Processing Section 71

Once the set of data has been collected for the user premises, the processing section 71 is responsible for analyzing the data and determining a recommended location for the placement of the LTE modem.

The processing section 71 contains a throughput estimator 73, a normalizer function 75 and a utility function 77, a throughput thresholds store 79 and also accesses the signal mapping store 69.

The throughput estimator 73 performs a function which converts the received metrics from the LTE radio manager 63 and the WLAN radio manager 61 at each sample location into a throughput estimate in megabits per second (Mbps).

This process is useful because the units of metric information for the cellular connection and the WLAN connection are not directly comparable and furthermore, even when the variables, such as SINR, have the same name, the thresholds used in the different wireless technologies are different.

In this embodiment, the measured LTE statistics are Reference Signal Received Power (RSRP) in dBM and SINR in dB, while for WLANs the statistics are Received Signal Strength Indication (RSSI) in dBM and SINR in dB.

The throughput estimator 73 uses conversion tables/calculators stored in thresholds store 79 to convert the different sets of measurements for the LTE signal and WiFi signal respectively into an indicative throughput in Mbps of each link so that the values can be directly compared.

In this embodiment, the LTE radio interface and WiFi radio interface each obtain two metrics per sampling point to provide a more accurate indication of throughput.

Table 2 shows a RSSI to Throughput conversion table used in the first embodiment:

TABLE 2

| RSSI | Throughput (Mbps) |
|---|---|
| −77 | 15 |
| −73 | 30 |
| −71 | 45 |
| −68 | 60 |
| −64 | 90 |
| −61 | 120 |
| −59 | 130 |
| −57 | 150 |
| −53 | 180 |
| −51 | 200 |

Table 3 shows a SINR to throughput conversion table used in the first embodiment:

TABLE 3

| SINR | Throughput (Mbps) |
|---|---|
| −0.2 | 15 |
| 3.8 | 30 |
| 5.8 | 45 |
| 8.8 | 60 |
| 12.8 | 90 |
| 15.8 | 120 |
| 17.8 | 130 |
| 19.8 | 150 |
| 23.8 | 180 |
| 25.8 | 200 |

For the WiFi values, often the RSSI values and the SINR values will map to a different throughput value. Therefore the lower of the derived RSSI and SINR throughputs is used as the estimated throughput. A similar process is carried out for the LTE metrics with respect to the RSRP and SINR values.

Table 4 shows an example of an RSRP to Throughput conversion table used in the first embodiment for the LTE signals.

TABLE 4

| RSRP (dBm) | Throughput (Mbps) |
|---|---|
| −140 | 0 |
| −130 | 0 |
| −120 | 2 |
| −110 | 5 |
| −100 | 30 |
| −90 | 75 |
| −80 | 90 |
| −70 | 90 |
| −60 | 90 |
| −50 | 90 |
| −44 | 90 |

Table 5 shows a SINR to throughput conversion table used in the first embodiment for the LTE signals.

TABLE 5

| SINR | Throughput (Mbps) |
|---|---|
| −5 | 3 |
| 0 | 7 |
| 5 | 15 |
| 10 | 33 |
| 15 | 51 |
| 20 | 70 |
| 25 | 82 |
| 30 | 90 |
| 35 | 90 |

Table 5 relates to a 2×2 MIMO LTE device operating with a single 20 MHz carrier. Different tables are required depending on the MIMO levels and levels of carrier aggregation used by the LTE modem.

### Normalization

Once the metrics have been collected and converted into a throughput value, the WLAN throughput values are normalized by the normalization function 75 to take into account the presence of other devices using the WLAN in addition to the LTE modem 21.

In this embodiment, the hub 3 generates a single 2.4 GHz WLAN 13 and therefore the LTE modem 21 will be using the same Wi-Fi channel as other client connections. When a WLAN device 11 requires data from an Internet resource, the data packets will travel via the WLAN 13 to the hub 3 and then potentially from the hub 3 to the LTE modem 21 via the WLAN 13 if the hub 3 decides to send the packets via hybrid access. This arrangement may mean that the Wi-Fi channel will receive double loading when Wi-Fi clients are accessing internet resources via the hub 3 and cellular modem 21. Therefore the normalizer function 75 adjusts the Wi-Fi throughput figures to account for this double use of the channel. In this embodiment, the normalization is achieved to estimate the worst case scenario by dividing the measured Wi-Fi throughput figures by two.

After the processing by the normalizer function 75, each set of measurement values associated with each sampling location are updated with the newly calculated throughput values. Table 6 shows the updated measurement table.

TABLE 6

| | LTE measurements | | | WiFi measurements | | | User |
|---|---|---|---|---|---|---|---|
| Sample | RSRP | SINR | Throughput | RSSI | SINR | Throughput | location |
| # | (dBm) | (dB) | (Mbps) | (dBm) | (dB) | (Mbps) | grid ref |
| 1 | −120 | 0 | 2 | −51 | 25.8 | 200 | 5, 0, 0 |
| 2 | −60 | 30 | 90 | −68 | 8.8 | 60 | 0, 0, 0 |
| 3 | −110 | −5 | 3 | −57 | 8.8 | 60 | 3, 3, 0 |
| 4 | −70 | 25 | 82 | −71 | 8.8 | 45 | 0, 6, 0 |
| 5 | −70 | 25 | 82 | −59 | 17.8 | 130 | 5, 6, 0 |
| 6 | −80 | 20 | 70 | −59 | 15.8 | 120 | 4, 5, 1 |
| 7 | −60 | 30 | 90 | −77 | −0.2 | 15 | 0, 5, 1 |
| 8 | −90 | 20 | 70 | −68 | 8.8 | 60 | 1, 3, 1 |
| 9 | −100 | 10 | 30 | −71 | 5.8 | 45 | 2, 0, 1 |
| 10 | −110 | −5 | 3 | −59 | 17.8 | 130 | 4, 0, 1 |

### Utility Function

Having generated a set of comparable throughput figures for the LTE and WLAN connections at various LTE modem 21 candidate locations around the user premises, the utility function 77 processes the set of updated sample point data to generate a utility score for each location. The utility score is a measure of the suitability of a location for LTE modem placement and can be measured in a number of ways.

In this embodiment, the utility function processes the sample point n-tuple data sets in the updated measurement table to identify the minimum value of the LTE and WLAN throughput values. This value is used as the utility value and represents the lowest expected minimum speed over either data link at each location.

Once utility values for all of the sample point data have been calculated and stored as an updated measurement table, a recommended LTE modem location is identified by searching for the location having the highest utility score. Furthermore the scanned locations are ranked according to utility score so that the worst location and also alternate recommended locations are identified. The alternative locations are useful for situations where the user decides that they cannot place the LTE modem in the recommended location for practical reasons but would still like a close to optimal location for the LTE modem within the user premises.

### Visualizer

The output section 81 includes a floor plan to utility visualizer 83 and accesses the signal mapping store 69.

In the output section 81, since the user may not remember their scan route, the floor plan visualizer 83 is configured to visually display the results of the processing overlaid on the user provided map of the user premises. The floor plan visualizer 83 retrieves the ranked data set and the floor plan for the user premises. As shown in FIG. 3, the visualizer 83 increases the size of the sample point marker and line thickness. In addition, the visualizer 83 can modify the screen 47 output to show different colors to represent the suitability of each location for the placement of an LTE modem. For example green for the recommended location, orange for adequate locations and red for the worst location. The results are displayed on screen 47 of the mobile device 11b.

With the processing of the above functional units in the application of the mobile device, various candidate locations with a user premises are sampled to retrieve both LTE and WLAN performance data which is processed and used to provide guidance regarding where to place an LTE modem in the user premises for a hybrid access broadband system.

### Alternatives and Modifications

In the first embodiment, a mobile device having both an LTE radio interface and a WLAN interface has an application for simulating the functionality of an LTE modem and processing the sampled data results to recommend a location of an LTE modem.

The LTE radio interface samples RSRP and SINR radio parameters and the WLAN radio interface samples RSSI and SINR radio parameters and a throughput estimator and normalizer converts those received parameters into an estimated throughput measurement so that the expected speeds of the LTE interface and WiFi interface can be directly compared.

This arrangement is advantageous because no changes are required at the hub or the LTE macrocell.

In an alternative, the hub is modified with a function to allow the mobile device to carry out a WiFi throughput measurement directly for use in determining the recommended LTE modem placement. Similarly an LTE throughput measurement function can be located in the LTE network core or directly at each macrocell.

With this arrangement, the performance parameter receiver operation is changed so that it connects with a respective speed tester at the macrocell and/or the hub, performs a speed test and then saves the results into the signal mapping store. The throughput estimator and normalizer and associated conversion tables are not required when both the macrocell and hub have the necessary speed test functions, or are only required as described in the first embodiment for either the LTE measurements or the WLAN measurements if one of the speed tester services is not available.

In the embodiment, a relatively simple normalization function was performed on the WLAN throughput values. In an alternative more complex system, the application is configured to retrieve state information about the hub's WLAN and therefore the behavior of the hybrid access system can be predicted to more accurately estimate the effect of having the LTE modem and WLAN clients on the same network. The following variables are collected by the normalizer from the hub.

C1—The set of clients connected to the hub using wires and sending traffic to the internet using hybrid access

C2—The set of clients connected to the hub using Wi-Fi and sending traffic to the internet using hybrid access

C3—The set of clients connected to the hub using Wi-Fi and sending traffic not destined for the internet plus third party clients (e.g. connected to other APs) visible at the hub.

TC1—The amount of traffic to/from the C1 clients

TC2—The amount of traffic to/from the C2 clients

TC3—The amount of traffic to/from the C3 clients

Φ2 The average physical transmission/reception rate of the C1 clients

Φ3 The average physical transmission/reception rate of the C2 clients

Φ4 The average physical transmission/reception rate of the Hub to LTE modem Wi-Fi link

D=Peak amount of DSL traffic

L=Peak amount of LTE traffic
F—The fraction of internet traffic that will go over the cellular link at peak load (F=L/(D+L)).

The normalizer function 75 calculates the proportion of Wi-Fi airtime used by the various clients (as a proportion of the available airtime).

C1 airtime fraction AF1=TC1/Φ1

C2 airtime fraction AF2=TC2/Φ2

C3 airtime fraction AF3=TC3/Φ3

Hub to LTE modem airtime fraction AF4=F*(TC1+TC2)/Φ4

Note, the Wi-Fi speed tester is essentially measuring Φ4, at an assumed airtime fraction of 1.

If the clients and the LTE modem are using the same Wi-Fi channel for connection to the hub, the throughput normalization factor NF=(1−AF3)*AF4/(AF4+AF2)

(c) Other normalizations are possible, e.g. to take account of traffic that will only be routed over the DSL link (and therefore only traversing Wi-Fi once, rather than twice).

In the embodiment, the hub generates a WLAN using the 2.4 GHz frequency which is shared between all WLAN devices including the LTE modem. This can result in the WLAN performance/throughput being variable depending on the load on the WLAN. In an alternative, the hub is capable of forming two WLANs using different 802.11 frequencies, namely 2.4 GHz and 5 GHz. To improve the stability of the connection between the hub and the mobile device for determining the recommended location of the LTE modem, the hub is configured to provide one WLAN exclusively for the mobile device/LTE modem while other devices are steered to the other frequency. Since the 2.4 GHz and 5 GHz frequencies have different characteristics, the mobile device is configured to obtain WLAN measurements for both frequencies in addition to the LTE measurements so that it provides a recommended location if the WLAN link is using 2.4 GHz and a second recommended location if the WLAN link is using 5 GHz.

It is also well known to connect user premises devices to a hub using wires such as Ethernet cables or Power line adaptors which transmit LAN signals using the user premises electrical power ring. In an alternative, the application running on the mobile device will recommend a location for the LTE modem based on an assumption that the LTE modem link to the hub is a wireless link. The mobile device will typically not have a wired connection interface and therefore cannot measure the throughput for a wired connection. However, since the characteristics of a wired connection are much easier to model and predict, the user can indicate that they intend to use a wired connection between the LTE modem and the hub which causes the application to substitute the WLAN readings with a typical wired connection set of estimations and recalculate the recommended locations list.

In the embodiment, the sample measurements are only taken at locations indicated by the user to indicate they are at a power socket. To improve the range of possible locations for the hub and remove local spikes/dips in reception affecting the recommendations, in an alternative, the application is configured to regularly take sample measurements between user selected scan sites.

After scanning is complete for the user premises, the locations for the intermediary scans are interpolated from the user's selected points. The larger set of data can then be analyzed and used to remove the effect of temporary spikes/dips in the measurement data and recommendations. In an alternative to the operation of the utility function, a running minimum function is applied to the utility function of the embodiment e.g. the minimum over lm either side of the scan location to produce a new utility function. The maximum value of this utility function should indicate the centre of a relatively large area of good performance.

In a yet further modification, the difference between the peak values of the utility functions in the first embodiment and the alternative described above is calculated. If this difference is above a certain threshold, then for best performance accurate positioning of the repeater is essential. In this case an extra stage is introduced for positioning of the LTE modem whereby live performance measurements are taken during the final positioning, and the user is presented with a live indication of the Utility 1 function value.

1. A method of assessing potential locations for a hybrid access modem for connection to a hybrid access home gateway, the method being performed by a device having both a cellular interface and a wireless local area network data interface, the method comprising:
retrieving a plurality of data sets of performance data at various locations within a premises, each data set comprising cellular network metrics and wireless local area network metrics;
determining a utility score for each of the data sets, the utility score representative of suitability for a hybrid access modem placement; and
identifying a recommended location for a hybrid access modem.

2. The method according to claim 1, wherein the performance data relates to a first set of cellular network signal strength metrics and a second set of wireless network signal strength metrics and further comprising:
converting the first set and the second set into a third set of data throughput values.

3. The method according to claim 1, further comprising connecting to a server located in a cellular network and carrying out a data transfer test to determine available throughput metrics at each location.

4. The method according to claim 1, further comprising connecting a speed test function located within the hybrid access home gateway to run a speed test to determine available throughput metrics at each location.

5. The method according to claim 1, further comprising receiving a floorplan for a user premises in which the hybrid access home gateway is situated, and visually indicating the recommended location as an overlay on the floorplan.

6. The method according to claim 5, wherein the collected data sets associated with each location are ranked according to utility score and displayed on the floorplan.

7. The method according to claim 5, wherein metrics are retrieved in response to a user input to indicate a candidate location for the hybrid access modem, the method further comprising:
retrieving metric data at interim locations between user-initiated scans; and
indicating further candidate locations on the floorplan.

8. The method according to claim 1, further comprising normalizing the performance data to account for data flow behavior in the hybrid access network.

9. An apparatus for assessing potential locations for a hybrid access modem for connection to a hybrid access home gateway, comprising:
a cellular interface;
a wireless local area network data interface;
a receiver for receiving a plurality of data sets of performance data at various locations within a physical premises, each data set comprising cellular network metrics and wireless local area network metrics;
a processor for determining a utility score for each of the data sets, the utility score representative of suitability for a hybrid access modem placement and for identifying a recommended location for a hybrid access modem; and
a display for displaying the recommended location of the hybrid access modem.

10. The apparatus according to claim 9, wherein the performance data relates to a first set of cellular network signal strength metrics and a second set of wireless network signal strength metrics, and wherein the processor is further configured to convert the first set and the second set into a third set of data throughput values.

11. The apparatus according to claim 9, further comprising:
a transceiver for connecting to a server located on a cellular network, and configured to carry out a data transfer test to determine available throughput metrics at each location.

12. The apparatus according to claim 9, further comprising:
an input for receiving a floorplan for a user premises in which the hybrid access home gateway is situated; and
wherein the display is configured to visually indicate the recommended location as an overlay on the floorplan.

13. The apparatus according to claim 12, wherein metrics are retrieved in response to a user input to indicate a candidate location for the hybrid access modem, wherein the receiver is further configured to retrieve metric data at interim locations between user-initiated scans, and wherein the display is configured to indicate further candidate locations on the floorplan.

14. The apparatus according to claim 9, wherein the apparatus is configured to normalize the performance data to account for data flow behavior in the hybrid access network.

15. A non-transitory computer-readable storage medium comprising a computer program product storing processor executable instructions for causing a programmable processor to carry out the method as set out in claim 1.
